(19) United States
(12) Patent Application Publication
(10) Pub. No.: US 2025/0276248 A1
(43) Pub. Date: Sep. 4, 2025

(54) PROGRAM, COMMUNICATION TERMINAL, AND GAMING SYSTEM

(71) Applicant: BANDAI CO., LTD., Tokyo (JP)

(72) Inventors: Satoshi TAKEDA, Tokyo (JP); Masahiko SAITO, Tokyo (JP); Kensuke MITA, Tokyo (JP)

(21) Appl. No.: 19/062,346

(22) Filed: Feb. 25, 2025

(30) Foreign Application Priority Data
Feb. 29, 2024 (JP) 2024-030537

(51) Int. Cl. A63F 13/795; A63F 13/35

(52) U.S. Cl. CPC A63F 13/795; A63F 13/35

(57) ABSTRACT

A program causes a computer that conducts a match in a competitive game to perform processes including a construction process for constructing a competitive deck to be used in the match on a basis of an operation input by a player, and a transmission process for transmitting, to a matching server in response to reception of an input operation relating to a start of playing of the match, a matching request to be matched with an opponent. In the competitive game, game elements of a first type and game elements of a second type appear. A game element of the first type and a game element of the second type can be registered to the competitive deck. The matching request is transmitted to the matching server in the transmission process on a condition that the game element of the first type be registered in the competitive deck.

### CROSS-REFERENCE TO RELATED APPLICATIONS

This application claims priority to Japanese Patent Application No. 2024-030537 filed in the Japan Patent Office on Feb. 29, 2024, the entire contents of which are incorporated herein by reference.

### BACKGROUND OF THE INVENTION

### 1. Field of the Invention

The present invention relates to a program, a communication terminal, and a gaming system, and more particularly to an electronic game in which players are matched with each other online.

### 2. Description of the Related Art

There are electronic games in which players are matched with each other online (Japanese Unexamined Patent Application Publication No. 2022-020788). Such electronic games include ones themed around trading card games (TCGs). In a TCG conducted in the real world, each of players can construct a deck including a plurality of cards on the basis of a desired strategy, and start playing a match with an opponent using the deck.

### SUMMARY OF THE INVENTION

Matching with an opponent and construction of a deck, however, take some time, and in an electronic game of a TCG in which a player is matched with an opponent online, time taken for the player to actually play a match can be long.

The present invention aims to provide a program, a communication terminal, and a gaming system that enables a player to start a match in a competitive game easily.

A program according to an aspect of the present invention causes a computer that conducts a match in a competitive game where players play against each other to perform processes including a construction process for constructing a competitive deck to be used in the match on a basis of an operation input by a player, and a transmission process for transmitting, to a matching server in response to reception of an input operation relating to a start of playing of the match, a matching request to be matched with an opponent, the matching request including information regarding the competitive deck constructed in the construction process. In the competitive game, game elements of a first type and game elements of a second type, which are different from the game elements of the first type, appear. A game element of the first type and a game element of the second type can be registered to the competitive deck. The matching request is transmitted to the matching server in the transmission process on a condition that the game element of the first type be registered in the competitive deck.

According to the present invention, the player can easily start a match in a competitive game.

### BRIEF DESCRIPTION OF THE DRAWINGS

FIG. 1 is a diagram illustrating an example of configuration of a gaming system according to embodiments and modifications of the present invention;

FIG. 2 is a block diagram illustrating an example of hardware configuration of a player terminal according to the embodiments and the modifications of the present invention;

FIG. 3 is a block diagram illustrating an example of hardware configuration of a server according to the embodiments and the modifications of the present invention;

FIG. 4 is a flowchart illustrating an example of a client process performed by the player terminal according to a first embodiment of the present invention;

FIG. 5 is a flowchart illustrating an example of a matching process performed by the server according to the first embodiment of the present invention;

FIG. 6 is a diagram illustrating an example of a challenge screen for displaying players who are matching candidates displayed on the player terminal according to a second embodiment of the present invention;

FIG. 7 is a diagram illustrating an example of a bet screen of a competitive game according to the second embodiment of the present invention;

FIG. 8 is a diagram illustrating an example of a match start screen displayed when a bet function is used according to the second embodiment of the present invention;

FIG. 9 is a flowchart illustrating an example of a process for determining a rank performed by the server according to a third embodiment of the present invention; and

FIG. 10 is a diagram illustrating matching criteria according to an eighth modification of the present invention.

### DESCRIPTION OF THE PREFERRED EMBODIMENTS

### First Embodiment

Embodiments will be described in detail hereinafter with reference to the accompanying drawings. The following embodiments do not limit the invention according to the claims, and not all combinations of features described in the embodiments are necessary for the invention. Any two or more of a plurality of features described in the embodiments may be combined together. The same or similar components will be given the same reference numerals, and redundant description thereof is omitted.

An embodiment described hereinafter is an example where the present invention is applied to, as an example of a gaming system, a gaming system that provides a service (competitive service) where a server that communicably connects to player terminals (communication terminals or gaming devices) used by players matches two players connected in the same period of time with each other and realizes a match in a competitive game in which the two players participate. The present invention, however, can be applied to a system that is achieved with any device configuration and that is capable of progressing an electronic game in which a plurality of players participates. A term “players” herein refers to users who log in to and use the competitive service provided by a server 200 in the gaming system.

### Configuration of Gaming System

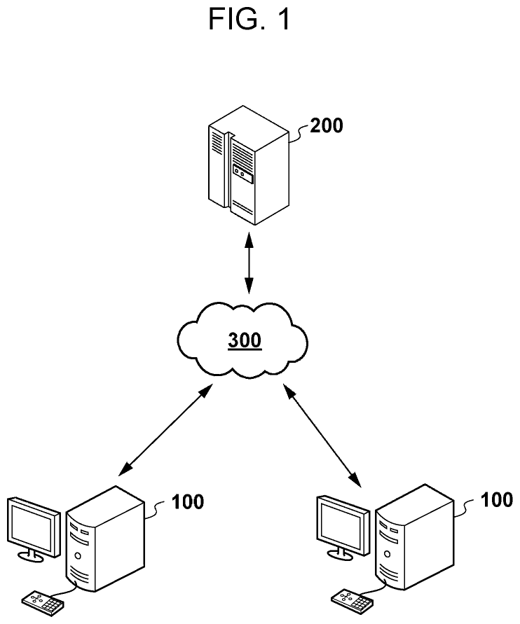

FIG. 1 is a diagram illustrating configuration of the gaming system according to the present embodiment. As illustrated in FIG. 1, in the gaming system, the server 200 and a plurality of player terminals 100 are communicably connectable to each other over a network 300. In the present embodiment, the server 200 matches two of players who are using the connected player terminals 100 as players of a match, provides a communication session for transmitting and receiving various types of information relating to the match, and provides a competitive service for realizing the match in which the two players participate.

Each player can log in to the competitive service by activating a predetermined client application using the player terminal 100. In the client application, for example, the player can make various settings and preparations for a match to be conducted, set a player profile, and play the match (a competition or an amusement). It is assumed that the competitive game (electronic game) that can be played in the competitive service according to the present embodiment is a trading card game (TCG) that progresses while arranging game elements, such as cards, on a predetermined game field, details of which will be described later. The player terminal 100 may be any communication terminal having a communication function, such as a personal computer (PC) or a smartphone.

### Hardware Configuration of Player Terminal

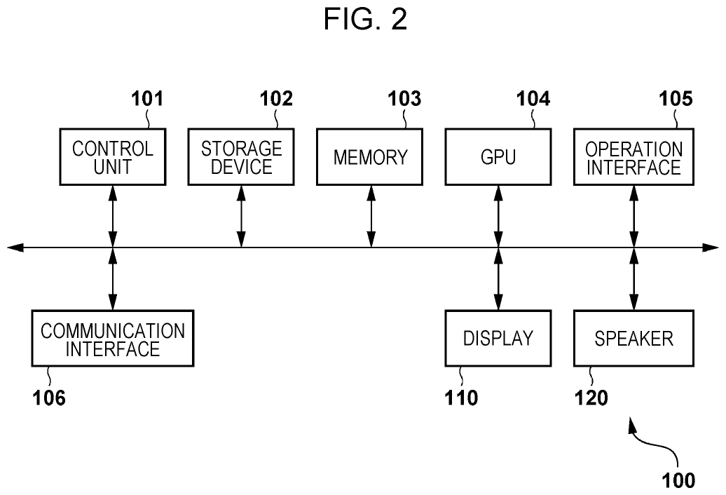

Next, hardware configuration of the player terminal 100 will be described with reference to FIG. 2. FIG. 2 is a block diagram illustrating an example of the hardware configuration of the player terminal 100.

A control unit 101 is a processor such as a central processing unit (CPU), and performs various types of control including control of operation of each of various pieces of hardware included in the player terminal 100. More specifically, the control unit 101 reads a necessary program stored in a storage device 102, for example, and performs a corresponding type of control by loading the program into a memory 103 and executing the program.

The storage device 102 is a device, such as a nonvolatile memory or a hard disk drive (HDD), capable of permanently storing information. The storage device 102 stores an operating system for operating the player terminal 100 and programs relating to various applications, as well as information regarding parameters necessary to achieve the various types of control and various types of data used to display information relating to a browser and execute the communication function. The memory 103 is a storage device, such as a volatile memory, used to temporarily store data. The memory 103 may be used not only as an area where each program is loaded but also as a storage area where data and the like output during the operation of the various types of hardware and the various types of control are temporarily stored.

A graphical user interface (GPU) 104 is a drawing device that performs various types of drawing processing relating to generation of display screens on the player terminal 100. The GPU 104 also performs processing for drawing game screens while the competitive game is being played. The GPU 104 includes a GPU memory, which is not illustrated, and generates various images including screens by expanding various types of graphics data read from the storage device 102 and performing predetermined arithmetic processing. The screens and the images generated by the GPU 104 are displayed on, for example, a display 110 included in the player terminal 100 and presented to the player. The display 110 is a device, such as a liquid crystal display, that is included in the player terminal 100 or removably attached to the player terminal 100 and that displays information. The display 110 displays the screens generated by the GPU 104.

An operation interface 105 is a user interface that is included in the player terminal 100 and that receives operation inputs. When the operation interface 105 detects an input operation, the operation interface 105 outputs a control signal corresponding to the input operation to the control unit 101. In a mode, the operation interface 105 includes operation members, such as buttons, various sensors, and the like provided on, for example, an exterior of the player terminal 100. The display 110 included in the player terminal 100 according to the present embodiment is configured to be able to detect touch inputs, and the operation interface 105 includes a touch input detection sensor provided for the display 110.

A communication interface 106 is a communication interface that is included in the player terminal 100 and that communicates with external apparatuses. Communication of information between the communication interface 106 and external apparatuses may be performed over a wide area network (WAN) such as the Internet, a local area network (LAN), or the like. The communication interface 106 wirelessly communicates information in the following description, but a mode in which wired communication is performed is not excluded.

A speaker 120 is an audio output interface included in the player terminal 100. The speaker 120 outputs various types of audio information including sounds relating to the client application.

### Hardware Configuration of Server

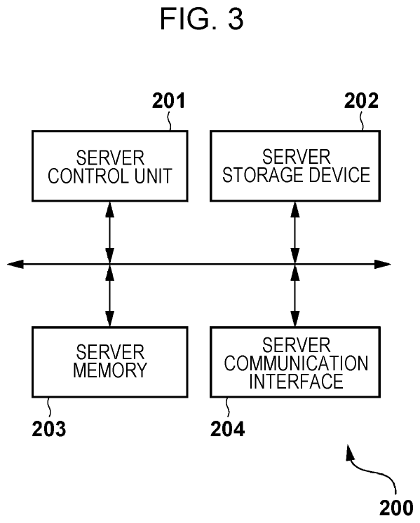

FIG. 3 is a block diagram illustrating hardware configuration of the server 200 according to the present embodiment. In the following description, hardware components for achieving the same functions as the player terminal 100 will be given a prefix “server” at beginnings thereof for distinction from counterparts in the player terminal 100.

A server control unit 201 is a processor such as a CPU, and performs control relating to achievement of various functions including control of operation of each of pieces of hardware included in the server 200, management of players relating to the competitive service, a function of matching players with each other, and communication and sharing of information for a match to be conducted. More specifically, the server control unit 201 reads a necessary program stored in a server storage device 202, for example, and performs a corresponding type of control by loading the program into a server memory 203 and executing the program.

The server storage device 202 is a device, such as a nonvolatile memory or an HDD, capable of permanently storing information. The server storage device 202 stores an operating system for operating the server 200 and programs relating to matching, as well as information regarding parameters necessary to achieve various types of control and various types of data necessary to provide the matching function. It is assumed that the server storage device 202 also has a database function of managing information regarding players registered as players in the gaming system. The server memory 203 is a storage device, such as a volatile memory, used to temporarily store data. The server memory 203 may be used not only as an area where each program is loaded but also as a storage area where data and the like output during the operation of the various types of hardware and the various types of control are temporarily stored.

A server communication interface 204 is a communication interface that is included in the server 200 and that communicates with external apparatuses. Communication of information between the server communication interface 204 and external apparatuses may be performed over a WAN such as the Internet, a LAN, or the like. The server communication interface 204 may communicate information by wire or wirelessly.

### Outline of Competitive Game

An outline of the competitive game that provides playing experience in the gaming system according to the present embodiment will be described hereinafter.

### Service Login

When the client application is executed on the player terminal 100, a game window relating to use of the service is displayed on the display 110 of the player terminal 100. The player can perform a procedure relating to service login by inputting a player identifier (ID) and a password, for example, in the game window. As a result of the procedure, the player terminal 100 transmits a service login request to the server 200 along with the input information. Upon receiving the service login request, the server control unit 201 checks authenticity of the input information by referring to player information registered in association with the player ID, for example, and if the authenticity is confirmed, manages the player as being in a login state. The player in the login state can use, via the game window, various functions provided by the service in relation to playing of a match.

### Construction of Deck

The functions provided by the service include a function of constructing a deck.

A match is played using a predetermine field defined in the competitive game. Each player can construct, for a match, a “deck” in which a set of game elements is registered, and play the match using the constructed deck.

In order to construct a deck, a player needs to obtain game elements using, for example, a lottery function or the like available for a fee. That is, game elements that the player can include in the deck to be constructed are limited to, for example, ones that the player has already obtained. The number of decks that a player can construct is not limited to one, and a plurality of decks with at least partly different game elements may be constructible.

Information regarding game elements obtained by each player and a deck constructed by the player is registered to the server storage device 202 in association with identification information (player ID) for uniquely identifying the player and managed. More specifically, the server storage device 202 also functions as a database that manages various types of information relating to each player as player information, and manages, in the player information, which is one record in the database, the player ID, information regarding game elements obtained by the player, and information regarding a deck constructed by the player in association with one another.

For example, by including element IDs for uniquely identifying game elements and the number of element IDs in the player information, the number of game elements obtained and owned by the player can be managed. In addition, for example, a deck constructed by the player is managed as information (deck information) regarding a deck constructed by the player by including identification information (deck ID) regarding the deck and element IDs of game elements included in the deck in the player information.

As described above, the competitive game that provides playing experience in the competitive service according to the present embodiment is a TCG, and game elements that are given to each player and that can be registered to a deck and used are cards (virtual cards that can be owned in the electronic game). In the competitive game according to the present embodiment, cards that can be used by each player are classified into two types, namely leader cards and member cards, which have different roles in the competitive game, and there is a condition that one leader card be included in a deck. In other words, a deck includes one leader card and a plurality of (one or more) member cards. Each card has a cost based on a degree of advantage in a match, for example, and the player needs to register cards to be included in a deck such that a total cost of the deck becomes a specified value.

In the competitive game, leader cards and member cards have different roles, which are, for example, as follows.

The leader cards limit member cards that can be included in a deck and determine a direction of the deck (policies on strategies to take to win a match). That is, by including one leader card in a deck, how a match for which the deck is used will play out is determined to some extent. The member cards, on the other hand, do not basically limit other cards that can be included in a deck.

A match is conducted in a turn-based manner, and each player sequentially places, on a field, cards registered to a deck used thereby in the player's turns. A leader card is placed on the field at a beginning of the match, and remains on the field during the match. Member cards, on the other hand, are randomly added to the player's hand from a deck of cards, and placed on the field at the player's discretion in each turn. That is, the leader cards and the member cards are different from each other in terms of whether placement on the field is mandatory.

In a match, a specified number of lives (a parameter indicating the number of times that a leader card can withstand an attack) are set for a leader card of each player at a beginning of the match. In a match according to the present embodiment, eight lives are consistently set for any leader card in order to ensure fairness between players. The match ends when the lives of a leader card of one of the players become zero or a deck of one of the players (the player's hand, a deck of cards, and member cards on the field) becomes zero. That is, each player can defeat an opponent by reducing the lives of the leader card of the opponent to zero or the deck of the opponent to zero. When the lives of the player's leader card become zero or the player's deck becomes zero, the player loses to the opponent.

Each card has an effect that occurs when the card is placed on the field in a match, and member cards each have a single effect that does not change in accordance with a progress parameter of a match. In contrast, leader cards differ from member cards in that a plurality of effects that switches in accordance with the progress parameter of a match is set. The progress parameter of a match may be, for example, lives of a leader card, and when the lives are reduced to half, an effect of making it possible to play the match more advantageously may be triggered.

When the player selects, in a menu, “construct a new deck” or “edit a constructed deck”, which relates to the function of constructing a deck, therefore, a state where a deck can be edited is established, and a list of cards managed as having been obtained by the player is displayed in the game window. By inputting an operation for selecting a desired card from the list, the player can select a card to be registered to the deck to be edited. More specifically, identification information (card ID) regarding the card selected as one to be registered to the deck is added to deck information regarding the deck to be edited. The deck information regarding the deck to be edited is, for example, temporarily held in the memory 103 of the player terminal 100 and updated each time a card to be registered is selected.

If “construct a new deck” is selected in the menu, new deck information is generated and held by the memory 103 as deck information regarding a deck to be edited. If “edit the constructed deck” is selected in the menu, on the other hand, deck information regarding the deck is downloaded from the server 200 to the player terminal 100 and held by the memory 103 as deck information regarding a deck to be edited.

When an operation relating to completion of construction is input, the deck information regarding the deck to be edited is uploaded from the player terminal 100 to the server 200 and managed after being included in the player information regarding the player. In the case of a new deck, the server 200 gives a new deck ID for the player, associates the deck ID with the uploaded deck information, and adds the deck information to the player information regarding the player. In the case of an already constructed deck, since a deck ID has already been associated with deck information regarding a deck to be edited, deck information having the same deck ID as the uploaded deck information in the player information regarding the player is updated on the basis of the uploaded deck information.

In order to avoid a situation where a storage area for the database is occupied by deck information in which no card is registered being included in the player information, deck information regarding a deck to be edited is uploaded only if one or more cards have been registered when an operation relating to completion of construction is input. That is, a deck need not necessarily be usable in a match at a time of completion of construction of the deck, and the player can complete construction and save deck information even when, for example, one or more cards under consideration for use are temporarily registered.

### Matching

Players can play a match in the competitive game using decks constructed using the function of constructing a deck. Since two players play a match in the present embodiment, players need to transmit matching requests to the server 200 from the player terminals 100 in order to start playing the match. Upon receiving the matching requests, the server control unit 201 performs processing for matching two players to play the match among players in the login state who have made the matching requests in the same period of time.

The client application, therefore, is provide with a function of playing a match, and configured to receive, when the function is executed, a request to start playing a match from a player. The player can input an operation relating to a request to start playing a match to be played (thereafter) by selecting one of constructed decks as a competitive deck. In the gaming system according to the present embodiment, players to play against each other are matched in consideration of decks to be used by the players, details of which will be described later, in order to increase entertainment value of the competitive game. When an operation relating to a request to start playing a match is input, therefore, the control unit 101 transmits a matching request including information regarding a competitive deck to the server 200 through the communication interface 106.

A matching request includes, for example, a player ID of a player and information indicating a competitive deck used by the player. The information indicating a competitive deck may be a deck ID, for example, and the server control unit 201 can refer to deck information regarding a competitive deck from corresponding player information on the basis of a player ID and a deck ID and identify cards registered to the competitive deck.

As described above, how a match develops varies depending on a competitive deck by a player, in particular a leader card included in the competitive deck. A characteristic of each leader card are mainly determined by an effect that can be triggered by the leader card, but in order to allow for a variety of playstyles, characteristics have favorable/unfavorable matchups. When a player consecutively matches with other players who use decks with unfavorable matchups for the player's deck, therefore, the player might become less interested in the competitive game. In the gaming system according to the present embodiment, therefore, a matching request includes information regarding a competitive deck, which is referred to in a matching process, which will be described later, performed by the server control unit 201.

In order to construct a competitive deck for achieving optimal game development, effects and costs set for leader cards and member cards need to be taken into consideration, which takes time. The matching process for providing playing experience of an entertaining match and matching a player who has made a matching request with an appropriate opponent, too, takes time depending on the time of day and other factors. That is, if a request to start playing a match is accepted on the condition that construction of a competitive deck be completed, time taken for a player who has logged in the service to start playing a match can be long.

In the gaming system according to the present embodiment, therefore, a request to start playing a match is accepted with a deck set as a competitive deck on the condition that at least a leader card be registered in the deck. That is, the player terminal 100 transmits a matching request to the server 200 on the condition that the deck selected as the competitive deck include at least one leader card.

In the game window relating to the client application, therefore, the player can display and check content of the competitive deck and edit the competitive deck even after the player inputs an operation relating to a request to start playing a match. A deck to be edited is limited to the competitive deck. It is assumed that, since the server 200 performs the matching process on the basis of information regarding a leader card in the competitive deck in response to the matching request, cards in the competitive deck other than the leader card, that is, only member cards, are editable after the request to start playing a match, details of which will be described later. Such a competitive deck can be edited only until matching with an opponent is completed.

### Matching Process

An outline of the matching process performed by the server 200 in relation to matching will be described hereinafter.

Since the competitive game played in the gaming system according to the present embodiment is a TCG in which two players play against each other, the server control unit 201 performs the matching process after receiving a matching request relating to a player from player terminal 100, and determines another player (opponent) to play against the foregoing player. The matching process is a process for matching, among players in the login state, players who have made matching requests in the same period of time. In order to provide entertaining playing experience, a plurality of matching criteria is provided in the matching process according to the present embodiment, and a player is extracted as the opponent on the basis of the criteria. Each matching criterion defines a condition of a player to be extracted as the opponent, and the server control unit 201 extracts, from among players from whom matching requests have been received in the same period of time, players who satisfy the conditions, and determines one of the players as the opponent. Order of priority is determined for the plurality of matching criteria, and the server control unit 201 basically extracts players who satisfy all the conditions relating to the matching criteria and determines one of the players as the opponent, but if there is no player who satisfies all the conditions, the server control unit 201 performs a process for extracting a player while sequentially excluding the matching criteria in ascending order of priority.

A first matching criterion in the matching process according to the present embodiment relates to a matching frequency with the same player. A result of a match is affected by experience and playing skills of players and elements such as cards owned by the players. In particular, the playing skills depend on the number of matches played by a player, and when there is a clear difference between the players, the player with higher playing skills tends to win even if the players play against each other consecutively. As a result, the player with lower playing skills tends to lose consecutively, and can become less interested in the competitive game. In a mode in which the same players are consecutively matched with each other, a player can intentionally match with the same player by, for example, repeatedly playing the game in the time of day when the number of players in the login state is small, and rig a winning percentage of the opponent by, for example, intentionally surrendering to the opponent repeatedly.

For this reason, the first matching criterion is based on a condition that an opponent to be matched with a player who has made a matching request be not any of opponents in a predetermined number of matches played by the player most recently. In order to facilitate understanding of the invention, a mode in which the predetermined number is one will be described in the present embodiment so that consecutive matching with the same player is avoided. That is, in the following description, the first matching criterion uses a condition that an opponent of a player who has made a matching request be not another player with whom the player has been matched most recently. Embodiments of the present invention, however, are not limited to this, and control may be performed such that, for example, a player is not matched with another player with whom the player has been matched most recently, until a predetermined number of matches, namely two or more matches, with other players are played, instead.

A second matching criterion in the matching process according to the present embodiment relates to a matching frequency with players who use decks including the same leader card. As described above, development of a match can depend on a leader card included in a deck. If it is possible to consecutively play against players with decks including the same leader card, therefore, playing experience of matches with similar game development is provided for the player, and the player might be tired of playing the game. Especially when a player plays against players with decks including a leader card with an unfavorable matchup, the player is forced to play difficult matches, and can lose interest in the competitive game.

For this reason, the second matching criterion is based on a condition that a leader card in a deck of an opponent to be matched with a player who has made a matching request be different from leader cards in decks of opponents in a predetermined number of matches played by the player most recently. In order to facilitate understanding of the invention, a mode in which the predetermined number is one will be described in the present embodiment, so that consecutive matching with players who use decks including the same leader card is avoided. That is, in the following description, the second matching criterion uses a condition that a leader card be different from one included in a deck used by a player against which a player who has made a matching request has played most recently. Embodiments of the present invention, however, are not limited to this, and control may be performed such that, for example, a player is not matched with another player who uses a leader card used in a deck of a most recent opponent until a predetermined number of matches, namely two or more matches, with other players who use decks including other leader cards are played, instead.

A third matching criterion in the matching process according to the present embodiment uses a condition that an opponent of a player who has made a matching request be another player who uses a deck including a leader card different from one used by the player. Each player constructs a deck in consideration of a characteristic of a leader card, but it is difficult to make the most of the characteristic when the player plays against a deck including the same leader card, and game development can be monotonous. For this reason, the third matching criterion uses a condition that an opponent to be matched with a player who has made a matching request use a deck including a leader card different from one included in a competitive deck used by the player.

The server control unit 201 determines, on the basis of the three matching criteria, another player to be matched with a player who has made a matching request. Priority decreases in order of the first matching criterion, the second matching criterion, and the third matching criterion, and the server control unit 201 extracts a player while appropriately rearranging these matching criteria, in order to determine an opponent among players who have made matching requests in the same period of time.

In a mode in which player A has played most recently against player B who has used a deck including leader card b and player A uses a competitive deck including leader card a in a next match, for example, the server control unit 201 receives a matching request from player A and extracts players who meet all the matching criteria. That is, the server control unit 201 extracts players who are not player B (first matching criterion) and who use decks including leader cards other than leader card a and leader card b (second and third matching criteria). If there are players who meet all the matching criteria (one or more players are extracted) at this time, the server control unit 201 determines one of the players as the opponent. If there is no player who meets all the matching criteria, on the other hand, the server control unit 201 extracts players again while excluding the lowest priority matching criterion (the third matching criterion in this case). More specifically, the server control unit 201 extracts players who are not player B (first matching criterion) and who use decks including leader cards other than leader card b (second matching criterion). If no player can be extracted even with these conditions, the server control unit 201 extracts players again while further relaxing the conditions (excluding the second matching criterion).

The server control unit 201 thus determines the opponent to be matched with a player who has made a matching request by extracting players on the basis of the predetermined conditions while relaxing the conditions as necessary, in order to provide optimal playing experience. When there is no applicable player even with the first matching criterion alone, the server control unit 201 may, for example, randomly determine one of players who have made matching requests in the same period of time as the opponent, or extend a search period until a predetermined timeout period elapses, and search for players who meet the matching criterion again.

After completing the matching of players, the server control unit 201 provides a communication session for communicating various types of information relating to a match in which the two players matched with each other are to participate. Information regarding the communication session is transmitted to the player terminals 100 used by the two players along with, for example, information regarding a matching result. Upon receiving the information regarding the communication session, the control units 101 of the player terminals 100 start a process for connecting to the communication session.

### Playing Match

After the player terminals 100 of the two players who have been matched with each other and who are to play against each other are connected to the communication session, the players can start playing a match. When the player terminals 100 of both players are connected to the communication session, the client application that is being executed by each player terminal 100 starts processing relating to the playing of the match to display a match screen.

Here, the match is played on the condition that the competitive deck include one leader card and one or more member cards, and when the processing relating to the playing of the match is started, the competitive deck becomes uneditable to ensure fairness. If the competitive deck used by the player includes no member card before the processing relating to the playing of the match starts, therefore, an operation relating to selection of at least one member card may be input, and the processing relating to the playing of the match may be performed as the deck information is updated as a result of the addition of the member card.

In the processing relating to the playing of the match performed by each player terminal 100, various types of information for progressing the match are configured on the basis of operations input by the player for the match and transmitted to the server 200. The server 200 manages the various types of information for progressing the match in each communication session, and performs processing for transmitting (sharing) the information received from the player terminal 100 to the other player terminal 100 participating in the communication session. In the processing relating to the playing of the match, when information for progressing the match relating to the opponent is received from the server 200, the display of the match screen is controlled on the basis of the information. As a result, the gaming system can provide playing experience where remote players play against each other through the server 200.

### Client Process

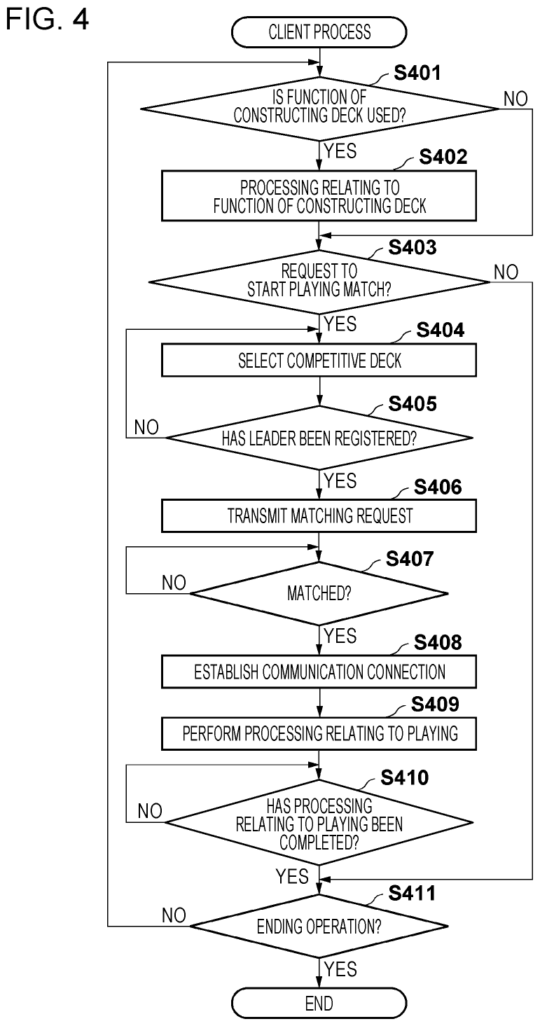

A specific example of the client process performed by the player terminal 100 according to the present embodiment in relation to the client application will be described hereinafter with reference to a flowchart of FIG. 4. The process corresponding to the flowchart can be achieved when, for example, the control unit 101 reads a corresponding processing program stored in the storage device 102, loads the processing program into the memory 103, and executes the processing program. In the following description, the client process is started when, for example, the player terminal 100 executes the client application and the player logs in to the service. In the description of the client process, a player who uses the player terminal 100 that is performing the process and who has logged in to the service will be referred to as a “target player”.

In S401, the control unit 101 determines whether an operation relating to use of the function of constructing a deck has been input. If determining that an operation relating to use of the function of constructing a deck has been input, the control unit 101 causes the process to proceed to S402, and if not, the control unit 101 causes the process to proceed to S403.

In S402, the control unit 101 performs processing relating to the function of constructing a deck. Although description of details of the processing relating to the function of constructing a deck is omitted in the present embodiment, deck information can be added to or updated in player information regarding the target player by using the function of constructing a deck as described above.

In S403, the control unit 101 determines whether an operation relating to a request to start playing a match has been input. If determining that an operation relating to a request to start playing a match, the control unit 101 causes the process to proceed to S404, and if not, the control unit 101 causes the process to proceed to S411.

In S404, the control unit 101 receives selection of a deck (competitive deck) to be used by the target player in the match. The competitive deck is selected on the basis of an input operation for selecting one of decks constructed by the target player. Prior to the selection, the control unit 101 obtains deck information registered in relation to the player from the server 200 and displays corresponding decks on the display 110 in a selectable manner.

In S405, the control unit 101 determines whether a leader card is registered in the deck selected in S404. If determining that a leader card is registered in the selected deck, the control unit 101 causes the process to proceed to step S406, and if not, the control unit 101 returns the process to S404. In the latter case, for example, the server control unit 201 may display, on the display 110, a notification for prompting the player to select a deck in which a leader card is registered.

In S406, the control unit 101 transmits, to the server 200, a matching request including a deck ID of the deck selected in S404 as a deck ID of the competitive deck. In response to the matching request, the server 200 performs the matching process to determine a player as an opponent (hereinafter referred to as an opponent player).

In S407, the control unit 101 determines whether the opponent player has been matched. The determination in this step can be made on the basis of whether information regarding a matching result has been received from the server 200. If determining that the opponent player has been matched, the control unit 101 causes the process to proceed to S408, and if not, the control unit 101 repeats the processing in this step.

In S408, the control unit 101 establishes a communication connection with a communication session to be connected through the communication interface 106 on the basis of information regarding the communication session included in the information regarding a matching result.

In S409, the control unit 101 performs processing relating to playing of the match.

In S410, the control unit 101 determines whether the processing relating to the playing of the match started in S409 has been completed. The processing relating to the playing of the match ends when the match conducted satisfies ending conditions and a result of the match is finalized. If determining that the processing relating to the playing of the match has been completed, the control unit 101 causes the process to proceed to S411, and if not, the control unit 101 repeats the processing in this step.

In S411, the control unit 101 determines whether an operation relating to ending of the client application has been input. If determining that an operation relating to ending of the client application has been input, the control unit 101 ends the client process, and if not, the control unit 101 returns the process to S401.

### Matching Process

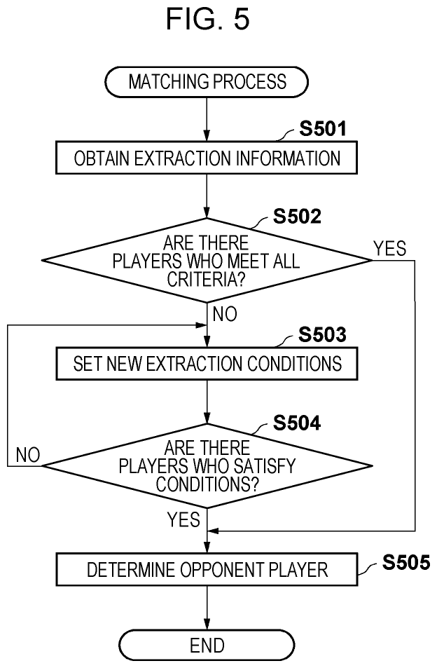

Next, a specific example of the matching process performed by the server 200 according to the present embodiment will be described with reference to a flowchart of FIG. 5. The process corresponding to the flowchart can be achieved when, for example, the server control unit 201 reads a corresponding processing program stored in the server storage device 202, loads the processing program into the server memory 203, and executes the processing program. In the following description, the matching process is started when, for example, a matching request is received from any player terminal 100. In the description of the matching process, a player from whom a matching request has been received will be referred to as a “target player”, other players who have made matching requests in the same period of time will be referred to as “standby players”, and a player matched with the target player will be referred to as an “opponent player”.

In S501, the server control unit 201 obtains information (extraction information) for extracting the opponent player. In the present embodiment, the server control unit 201 obtains a player ID of a player who has been matched with the target player most recently (hereinafter referred to as a previous player), a card ID of a leader card relating to the previous player in a previous match, and a card ID of a leader card in a competitive deck of the target player. Various types of information regarding the previous player may be obtainable from, for example, information regarding a match history included in player information regarding the target player.

In S502, the server control unit 201 determines, on the basis of the extraction information, whether the standby players include players who meet all the matching criteria. That is, the server control unit 201 sets the three matching criteria as extraction conditions and attempts to extract players who satisfy the extraction conditions from the standby players. If determining that the standby players include players who satisfy all the matching criteria, the server control unit 201 causes the process to proceed to S505, and if not, the server control unit 201 causes the process to proceed to S503.

In S503, the server control unit 201 sets new extraction conditions by excluding the lowest priority matching criterion from the matching criteria set as the current extraction conditions.

In S504, the server control unit 201 determines, on the basis of the extraction information, whether the standby players include players who satisfy the new extraction conditions. If determining that the standby players include players who satisfy the new extraction conditions, the server control unit 201 causes the process to proceed to S505, and if not, the server control unit 201 returns the process to S503. If no conditions relating to any matching criteria are set as extraction conditions, the server control unit 201 determines that all the standby players satisfy the new extraction conditions.

In S505, the server control unit 201 extracts the players who satisfy the extraction conditions from the standby players, and determines one of the players as the opponent player. The opponent player may be determined, for example, by lot. The server control unit 201 sends a player ID of the determined opponent player back to the player terminal 100 used by the target player as information regarding a matching result, and ends the matching process. At this time, the server control unit 201 also transmits, to the player terminal 100 used by the opponent player, information regarding a matching result indicating that the opponent player has been matched with the target player.

As described above, with the communication terminal according to the present embodiment, the player can easily start a match. With an information processing apparatus according to the present embodiment, entertaining matching can be provided.

### First Modification

Although a condition that the opponent player be not any of opponents in a predetermined number of matches played by the target player most recently is used as the first matching criterion in the above embodiment, embodiments of the present invention are not limited to this. When a difference in playing skills between the target player and the opponent player is small, for example, it is hard to envision a situation where a match develops one-sidedly, even if these players rematch. In other words, when a difference in playing skills between the target player and the opponent player is large, a match can develop similarly if these players rematch in a short period of time, but a match is unlikely to develop similarly between players with little difference in playing skills.

For this reason, in a mode in which attribute information such as a game level, the number of matches played, and a rank based on game results is included in the player information and managed, the predetermined number of matches taken to be able to match the target player with the opponent player may be increased or decreased on the basis of the attribute information regarding the target player and attribute information regarding the opponent player. For example, a plurality of ranges may be provided for a difference in the number of matched played between players, and the predetermined number of matches may be changed on the basis of which range the difference falls within. In this case, the predetermined number of matches may be increased for a larger range.

### Second Modification

In the above embodiment and modification, a mode in which, in order to rematch the target player with an opponent player against whom the target player has played once, the target player needs to play the predetermined number of matches without matching with the opponent player, that is, a mode in which the number of matches played is used as a condition for rematching between the same players, has been described. Embodiments of the present invention, however, are not limited to this, and elapse of a predetermined period of time may also be added as a condition.

### Third Modification

Although a mode in which member cards in the competitive deck can be edited even after a matching request is transmitted has been described in the above embodiment and modifications, embodiments of the present invention are not limited to this. In a mode, the competitive deck may be uneditable after a matching request is transmitted, if the competitive deck is completed (e.g., a difference between the total cost and a cost upper limit value is smaller than or equal to a threshold) at a time of the transmission of the matching request. Such a mode may be employed in order to perform appropriate evaluation in a game mode in which, for example, players are evaluated and ranked in accordance with game results, that is, a game mode that assumes “serious” matches between players.

### Second Embodiment

In the above first embodiment, a mode in which the server control unit 201 matches, upon receiving a matching request, a player who has made the matching request with one of other players who have made matching requests in the same period of time has been described. That is, in the gaming system according to the above embodiment, a matching method is employed in which a specified number of players to play against each other in a match are determined through the matching process performed by the server 200 without the intervention of the players' intentions. Matching methods used in online competitive games, however, are not limited to methods in which the server control unit 201 forcibly determines opponents. For example, there is a matching method in which some players enter a standby state to accept a challenge and other players who are not in the standby state each select a desired one of the players in the standby state and propose a match. Since a player who is not in the standby state can challenge a desired player to a match in this matching method, matching based on players' intention is achieved unlike in the first embodiment. In the present embodiment, a method for achieving entertaining matching in the matching method will be described.

### Matching

With the function of playing a match in the client application according to the present embodiment, when a request to start playing a match is received, whether to wait for a challenge from another player (hereinafter referred to as a challenge wait request) or challenge another player to a match (hereinafter referred to as a challenge request) is selected. In either case, the client application then receives selection of a competitive deck as in the first embodiment, and the player terminal 100 transmits a matching request to the server 200.

In the function of playing a match according to the present embodiment, transmission timing of a matching request differs depending on whether the target player has selected the challenge wait request or the challenge request.

More specifically, if the target player selects the challenge wait request, the player terminal 100 transmits a player ID of the target player, a deck ID of a competitive deck, and a matching request including the challenge wait request to the server 200 after the target player selects the competitive deck. Upon receiving the matching request, the server control unit 201 manages the target player by adding the target player to the standby players, who are in the standby state for a challenge to a match.

If the target player selects the challenge request, on the other hand, the player terminal 100 transmits the player ID of the target player, a deck ID of a competitive deck, and a “candidate obtaining request” including the challenge request to the server 200 after the target player selects the competitive deck. Upon receiving the candidate obtaining request, the server control unit 201 sends information regarding matching candidates including a plurality of standby players back to the player terminal 100 in order to allow the target player to select a player to challenge to a match. Upon receiving the information regarding matching candidates, the player terminal 100 used by the target player displays, in the game window relating to the client application, a challenge screen for displaying the players who are the matching candidates in a mode in which a challenge to a match can be accepted.

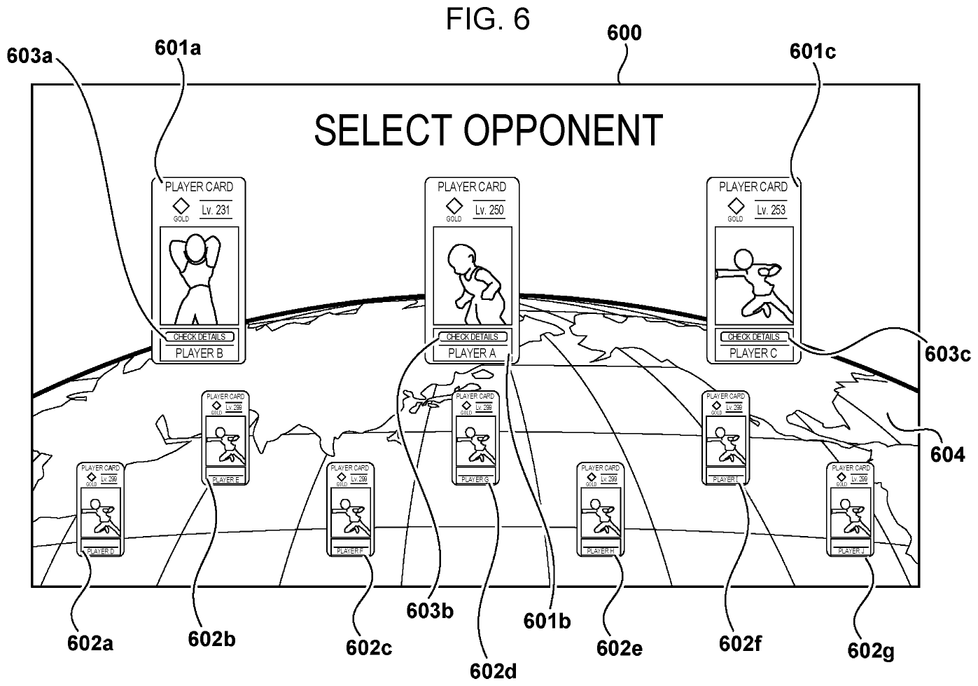

FIG. 6 illustrates an example of configuration of the challenge screen. A challenge screen 600 in the example of FIG. 6 is configured such that three standby players included in the information regarding matching candidates are arranged as matching candidates 601a to 601c, and a challenge to one of the standby players to a match can be accepted by, for example, inputting an operation in an area corresponding to the standby player. That is, the matching candidates 601a to 601c are ones with whom the target player can match, and a matching request including a player ID of one of the standby players who are the matching candidates is transmitted to the server 200 when the target player inputs an operation for selecting the matching candidate. Upon receiving the matching request, the server control unit 201 performs a process for matching the target player with the standby player identified from the player ID included in the matching request.

The matching candidates 601 do not include all the standby players who are waiting for a challenge to a match in the same period of time, and only include standby players, who have been selected by the server control unit 201, as many as or fewer than an upper limit value (three) of reception of a challenge to a match from the target player, details of which will be described later. By limiting the number of players displayed as the matching candidates 601, prolonged matching time due to the target player being unsure of which standby player to play against can be avoided.

Since the number of standby players displayed as the matching candidates 601 is limited, however, the target player might have an impression that few players are interested in the competitive game. For this reason, therefore, non-candidate players 602a to 602g are arranged in the challenge screen 600 in addition to the matching candidates 601a to 601c as livening-up elements as illustrated in FIG. 6. When sending the information regarding the matching candidates back to the player terminal 100, therefore, the server control unit 201 also transmits information regarding players to be displayed as the non-candidate players 602.

Since the players displayed as the non-candidate players 602 are livening-up elements, for example, the players may be selected from standby players who have not been selected as the matching candidates, may be selected from the players in the login state on the basis of a predetermined rule, or may be selected from all players including players in a logout state.

The matching candidates 601 and the non-candidate players 602 are different from each other in that the former are displayed in the challenge screen 600 in a manner that the target player can challenge to a match and the latter are displayed in a manner that the target player cannot challenge to a match. In addition, as illustrated in FIG. 6, the matching candidates 601 are displayed larger than the non-candidate players 602. The information regarding the matching candidates includes detailed information regarding the standby players, such as player names, game results, and attribute information, so that the target player can refer to the detailed information when selecting, from among the matching candidates 601, a standby player to challenge to a match. The matching candidates 601, therefore, are also different from the non-candidate players 602 in that detail display icons 603a to 603c are displayed for the matching candidates 601a to 601c, respectively, and detailed information regarding a corresponding standby player can be displayed in accordance with an operation input to one of the detail display icons 603a to 603c. That is, as illustrated in FIG. 6, detail display icons 603 are not displayed for the non-candidate players 602a to 602g, and the target player cannot check detailed information regarding the non-candidate players 602a to 602g.

The gaming system according to the present embodiment is configured such that players at various geographical locations can play against each other. For this reason, the server 200 need not be one server, but may be a set of a plurality of servers that operates together. In this mode, in order to show that the target player can play against players from various areas, a map image of the Earth is displayed in the challenge screen 600 as a background image 604. A position in the map image of the background image 604 displayed at the center may be changed on the basis of geographical information associated with the player terminal 100 (e.g., geographical position information regarding the player terminal 100). That is, when a Japanese player has made a candidate obtaining request, the map image of the background image 604 is displayed with Japan located at the center, and when an American player has made a candidate obtaining request, the map image of the background image 604 is displayed with the U.S. located at the center.

Although the matching candidates 601 and the non-candidate players 602 arranged in the challenge screen 600 are displayed as cards in the example of FIG. 6 since the competitive game played in the gaming system according to the present embodiment is a TCG, it can be easily understood that embodiments of the present invention are not limited to this.

In order to conduct a match with optimal game development, the server control unit 201 extracts, from the standby players, players to be matching candidates on the basis of a plurality of matching criteria as in the first embodiment. When extracting players to be matching candidates, the server control unit 201 sets extraction information on the basis of information included in the candidate obtaining request. In the present embodiment, the server control unit 201 obtains and sets, as the extraction information, a player ID of a previous player, who has been matched with the target player most recently, a card ID of a leader card relating to the previous player in a previous match, and a card ID of a leader card in a competitive deck of the target player. The server control unit 201 then extracts standby players as many as the upper limit value (three) on the basis of the extraction information and the three matching criteria. Processing relating to the extraction may be performed similarly to S501 to S505 in the matching process according to the first embodiment, but is different in that players as many as the upper limit value among the extracted players are determined as matching candidates and information regarding the matching candidates is sent back to the player terminal 100, not determining one of the extracted players as an opponent player.

If the players as many as the upper limit value include players who have met different sets of matching criteria, the information regarding the matching candidates may include information for identifying players who have met more matching criteria, and may be displayed in the challenge screen 600 such that the players can be distinguished from one another. That is, when there are two players who meet all the matching criteria and one more player has been extracted from among players who meet two of the matching criteria in order to secure matching candidates as many as the upper limit value, for example, the former two players are displayed in the challenge screen 600 differently from the other player because the former two players are likely to produce more entertaining game development.

Although a matching candidate and a target player are matched with each other when the target player challenges the matching candidate to a match in the gaming system according to the present embodiment in order to facilitate understanding of the invention, embodiments of the present invention is not limited to this. For example, the challenge screen 600 may continue to be displayed until the matching is completed (i.e., information regarding a matching result is received), assuming a case where the standby player is disconnected while waiting for a challenge to a match and a case where the standby player declines the challenge to a match in a mode in which players are allowed to choose whether to accept a challenge to a match, and the challenge screen 600 may be removed when the matching is completed. In this case, in order not to transmit matching requests redundantly, control may be performed such that, after a matching request is transmitted, the challenge screen 600 does not accept an input operation for selecting a matching candidate 601.

Since matching requests can be received from a plurality of player terminal 100 in the same period of time, standby players change every moment. For this reason, the server control unit 201 may update information regarding matching candidates at predetermined time intervals, for example, and regularly transmit the information to the player terminal 100. Upon receiving information regarding new matching candidates, the player terminal 100 used by the target player updates what is displayed in the challenge screen 600. When the target player has displayed detailed information regarding one of the matching candidates at a time of reception of the information regarding the matching candidates, it is estimated that the target player is considering a match with the matching candidate, and the control unit 101 may hold previously received information regarding matching candidates and keep displaying what is currently displayed in the challenge screen 600.

### Fourth Modification

Although players to be matching candidates are extracted on the basis of matching criteria based on a player against whom the target player has played most recently and a leader card in a deck in the above second embodiment as in the first embodiment, embodiments of the present invention are not limited to this. For example, in a mode in which the player information includes the attribute information regarding a player, such as the game level, the number of matches played, and the rank based on game results, a matching criterion relating to a degree of similarity of attribute information to the attribute information regarding the target player may also be included. The matching criterion uses a condition that attribute information regarding a player to be a matching candidate of the target player be similar to attribute information regarding the target player. Whether attribute information is similar may be determined on the basis of, for example, whether a difference in the game level, a difference in the number of matches played, and a difference in the rank are smaller than predetermined thresholds. With this configuration, players who have similar playing skills are more likely to play against each other, which increases the player's interest in the competitive game.

In this mode, the information regarding the matching candidates may include information regarding standby players of the same rank as the target player or standby players of lower ranks than the target player so that game development optimal to the target player who spontaneously challenges another player to a match is likely to be achieved. Alternatively, the information regarding the matching candidates can include information regarding standby players of higher ranks than the target player, but may be configured such that the number of standby players of lower ranks than the target player becomes larger than the number of standby players of higher ranks than or the same rank as the target player.

### Third Embodiment

In the above embodiments and modifications, a matching process for all the players in the login state has been mainly described. Because players use the service in various periods and have a variety of playstyles (playing frequencies and playing times of day) for the competitive game, on the other hand, playing skills of the players are naturally different from one another. For this reason, when players with a significant difference in playing skills are matched with each other in a game mode in which the matching process for all the players is performed, the player with lower playing skills might become less interested in the competitive game. The competitive game according to the present embodiment, therefore, includes a rank match mode as a game mode in which players with substantially the same playing skills tend to be matched with each other to achieve more entertaining matching.

### Rank Match Mode

In the rank match mode, players are given rank points in accordance with results of matches, and ranks of the players are determined in accordance with accumulated rank points. In a match in the rank match mode, players classified into the same rank are basically matched with each other. In other words, in the rank match mode, players are separated by rank, and the matching process is controlled in such a way as to match players in the same rank.

In a mode, six ranks, namely bronze, silver, gold, platinum, master, and god in ascending order, are provided. For each rank, rank points required for a player to be classified into the rank (a point threshold: minimum points for each rank) are defined, and higher points are set for higher ranks. That is, a highest one of point thresholds exceeded by accumulated rank points of a player is identified, and a rank corresponding to the highest point threshold is determined for the player. In a mode in which the point threshold of bronze is 0, the point threshold of silver is 10,000, the point threshold of gold is 30,000, the point threshold of platinum is 50,000, the point threshold of master is 70,000, and the point threshold of god is 90,000, for example, a rank of a player whose accumulated rank points are 55,000 is platinum.

When a player wins a match, the server control unit 201 determines to give fixed rank points to the player, and updates attribute information in corresponding player information. At this time, the server control unit 201 compares accumulated rank points after the update with the threshold of each rank to determine a rank into which the player is newly classified. When a player loses or draws in a match, on the other hand, the server control unit 201 does not give rank points to the player or update attribute information in corresponding player information.

In the rank match mode, therefore, more rank points are given to a player who has won more matches, and accordingly accumulated rank points increase and the player is classified into a higher rank. That is, a rank in the rank match mode corresponds to a parameter obtained by evaluating playing skills of each player. Information regarding a rank of each player in the rank match mode may be included in player information as attribute information and managed, and the server control unit 201 obtains the information regarding the rank in the matching process relating to the rank match mode and determines an opponent. With this configuration, a player with higher playing skills tends to be classified into a higher rank, thereby providing more entertaining playing experience of the competitive game while ensuring fairness.

### Bet Function

In a mode in which fixed rank points are given after winning a match, a player needs to play and win a considerable number of matches to be classified into an appropriate rank (a rank to which many other players with playing skills similar to those of the player belong). That is, in such a mode, a player with higher playing skills requires more wins and matches to be classified into an appropriate rank. Since time that can be used to play the game differs depending on an environment of a player, however, optimal playing experience might not be provided for some players.

In the competitive game according to the present embodiment, therefore, a bet function is provided in the rank match mode as a mechanism for facilitating appropriate classification of players into ranks regardless of the number of matches played. The bet function is a mechanism for enabling a player to obtain more rank points as an additional reward when the player wins a match. More specifically, the bet function is a function of betting, in a match conducted on the basis of a matching request made by a target player, at least some of rank points given to and associated with the target player on the target player's victory and giving rank points (a so-called dividend) according to the rank points bet on his/her victory (a so-called bet or stakes; hereinafter referred to as a bet element) in addition to fixed rank points. That is, the target player can increase the additional reward to be given thereto after winning a match by increasing rank points bet as the bet element. A player with high playing skills, therefore, can increase accumulated rank points faster by actively using the bet function, and easily reach an appropriate rank.

The bet element can be bet using the bet function until matching in the matching process is performed, in order to ensure fairness between players. The target player loses rank points bet as the bet element if he/she loses a match. That is, in a match for which the bet function is used, the bet element relating to the target player is temporarily deposited in the server 200 while being associated with the target player, and how the bet element is handled changes in accordance with a result of the match.

More specifically, if the target player wins the match, the bet element is returned to the target player while continuing to be associated with the target player, and rank points as the additional reward are also given to the target player. If the target player loses the match, on the other hand, the bet element is no longer associated with the target player, and the target player is not given the bet element (loses the bet element) or rank points as the additional reward. If the target player draws in the match, the bet element is returned to the target player while continuing to be associated with the target player, and rank points as the additional reward are not given.

Rank points as the additional reward are set smaller than the bet element in order not to excessively increase the number of players classified into high ranks. Percentage (dividend rate) of rank points given as the additional reward with respect to the amount of the bet element may desirably decrease as the amount of the bet element increases.

Since the accumulated rank points of the target player can vary depending on the process for giving or associating rank points in a match for which the bet function is used, the server control unit 201 determines a rank into which the target player is to be classified when the accumulated rank points have changed. That is, if the target player wins a match for which the bet function is used, more rank points are given to the target player, and it is possible that the target player is classified into a higher rank (promoted). If the target player loses a match for which the bet function is used, on the other hand, the target player loses some rank points, and it is possible that the target player is classified into a lower rank (demoted).

That is, the bet function puts the target player at risk, but the bet function also makes it easier for the target player to reach an appropriate rank and provides playing experience of a stimulating and entertaining competitive game.

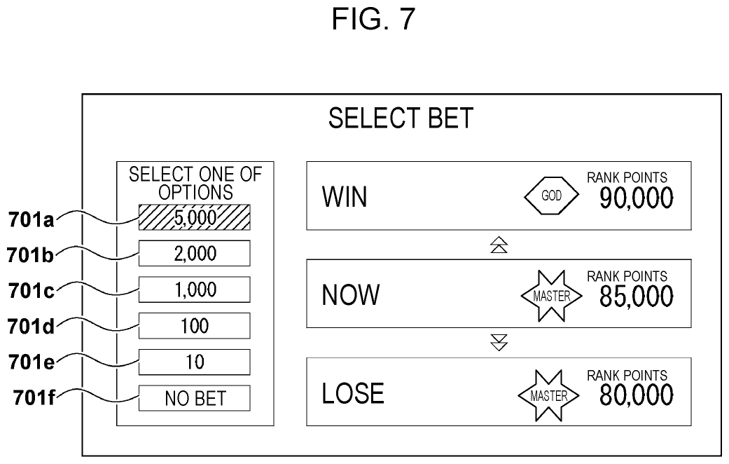

In the description of the competitive game according to the present embodiment, each player does not specify specific rank points to be bet using the bet function but selects one of options of predetermined values or predetermined units. As illustrated in FIG. 7, for example, the target player can select one of options 701a to 701f, which include no bet, on a bet screen for allowing the target player to specify the bet element. In the example of FIG. 7, the accumulated rank points of the target player are currently 85,000, and it is indicated that when the target player bets 5,000 of the selected option 701a, the target player will be given 1,000 as fixed rank points and 4,000 as an additional reward and the accumulated rank points will become 90,000 if the target player wins the match, and the target player will lose 5,000 as the bet element and the accumulated rank points will become 80,000 if the user loses the match.

Options that can be selected as rank points to be bet change in accordance with a rank into which the target player is classified, in order to secure game balance and prevent the rank from fluctuating wildly. That is, although the options 701a to 701e are illustrated in the example of FIG. 7 since the rank of the target player is master, the option 701a may be, for example, disabled or removed for platinum, which is one rank lower than master. In order to prevent the accumulated rank points from becoming a negative value, the specification of the bet element is accepted on the condition that the target player have rank points to be specified.

### Displaying Bet

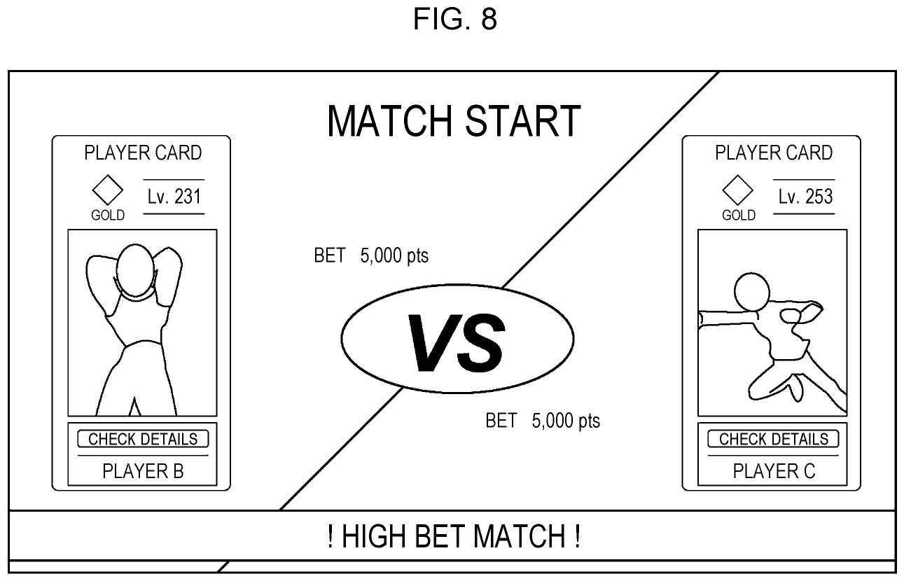

After a player who uses the bet function is matched, the bet element is displayed in a match start screen notifying of two players to play against each other as illustrated in FIG. 8, for example, in a mode in which all the players participating in a match can recognize. Such display of the bet element can be an indicator of each player's enthusiasm for the match and the like, which motivates the players to play the match and increases entertainment value.

In addition, depending on the total amount of bet elements of the two players in the match, the match may be made more entertaining by additionally displaying other effects in the match start screen and a match screen during the match, such as cheers and confetti.

Although details of the matching process are omitted in the present embodiment, with respect to a matching request relating to a player who has specified rank points larger than or equal to a predetermined value as the bet element, that is, a player who has placed a so-called high bet, a matching criterion for matching another player who has placed a similar bet with the foregoing player may be used in the matching process in the matching method in the first embodiment, for example, from the viewpoint of utilizing the effect of improving the entertainment value in accordance with the amount of the bet element.

### Process for Determining Rank

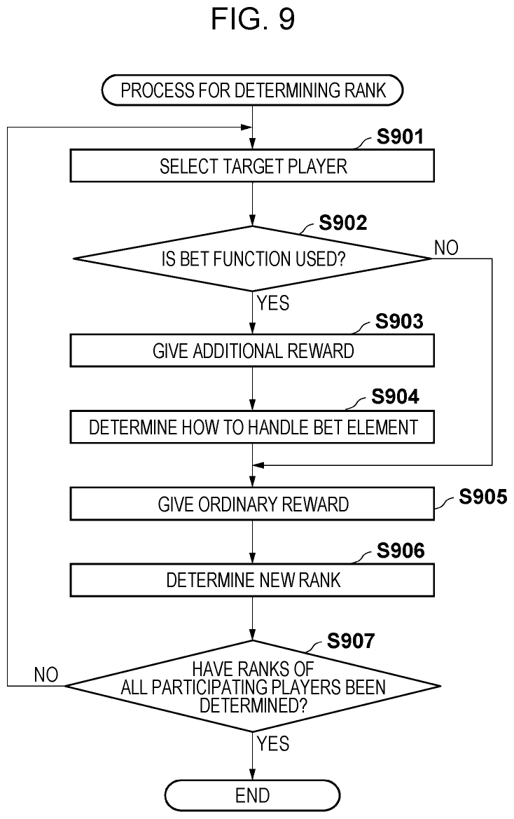

A process for determining a rank performed by the server 200 according to the present embodiment in relation to the rank match mode will be described hereinafter with reference to a flowchart of FIG. 9. The process corresponding to the flowchart can be achieved when, for example, the server control unit 201 reads a corresponding processing program stored in the server storage device 202, loads the processing program into the server memory 203, and executes the processing program. In the following description, the process for determining a rank is started when, for example, ending conditions of a match conducted in relation to the rank match mode in any communication session are satisfied. In the description of the process for determining a rank, a match whose ending conditions have been satisfied will be referred to as a “target match”.

In S901, the server control unit 201 selects, from among players who have participated in the target match, a player whose new rank has not been determined after the target match as the target player.

In S902, the server control unit 201 determines whether the target player has used the bet function for the target match. If determining that the target player has used the bet function, the server control unit 201 causes the process to proceed to S903, and if not, the server control unit 201 causes the process to proceed to S905.

In S903, the server control unit 201 determines rank points as an additional reward to be given to the target player on the basis of the target player's result of the target match and the bet element relating to the target player. If the target player has won the match, the server control unit 201 determines an additional reward according to the bet element and gives the additional reward to the target player. That is, the server control unit 201 performs a process for updating player information regarding the target player to change accumulated rank points by adding the additional reward. If the target player has drawn or lost in the match, the server control unit 201 determines the additional reward as zero. Since the accumulated rank points of the target player do not change, the server control unit 201 may only determine that the additional reward is zero, and need not perform the process for updating the player information regarding the target player.

In S904, the server control unit 201 determines how to handle the bet element deposited for the target player on the basis of the target player's result of the target match, and then actually handles the bet element. If the target player has won or drawn in the match, the server control unit 201 continues to associate the bet element with the target player, and returns the deposited bet element to the target player. Since the accumulated rank points of the target player do not essentially change, the server control unit 201 may only perform a process for canceling the deposit and need not perform the process for updating the player information regarding the target player. If the target player has lost the match, the server control unit 201 cancels the association between the bet element and the target player so that the target player loses the bet element. That is, the server control unit 201 performs the process for updating the player information regarding the target player to change the accumulated rank points by subtracting the bet element.

In S905, the server control unit 201 determines rank points as an ordinary reward based on the target player's result of the match. If the target player has won the match, the server control unit 201 gives the ordinary reward (fixed rank points) to the target player. That is, the server control unit 201 performs the process for updating the player information regarding the target player to change the accumulated rank points by adding a fixed value. If the target player has drawn or lost in the match, the server control unit 201 determines the ordinary reward as zero. Since the accumulated rank points of the target player do not change, the server control unit 201 only determines that the ordinary reward is zero, and need not perform the process for updating the player information regarding the target player.

In S906, the server control unit 201 determines a rank into which the target player is to be newly classified on the basis of the currently accumulated rank points of the target player. More specifically, the server control unit 201 compares the accumulated rank points of the target points with the point thresholds and determines the rank into which the target player is to be newly classified. After determining the new rank, the server control unit 201 updates the player information regarding the target player.

In S907, the server control unit 201 determines whether new ranks after the target match have been determined for all the players who have participated in the target match. If determining that new ranks have been determined for all the players, the server control unit 201 ends the process for determining a rank, and if not, that is, if determining that there is a player for whom a new rank has not been determined, the server control unit 201 returns the process to S901.

As described above, with the information processing apparatus according to the present embodiment, optimal playing experience of the game can be provided regardless of the number of matches played. That is, a player with high playing skills can be easily promoted to an appropriate rank, at which the player can play against other players with similar playing skills, thereby avoiding occurrence of matching with gaps in playing skills at lower ranks.

### Fifth Modification

Although a mode in which, when a target player loses a match for which the bet function is used, the target player can be demoted as a result of a decrease in his/her rank points has been described in the above third embodiment, embodiments of the present invention are not limited to this. Demotion is not favorable to players, and especially players of a low rank such as silver or gold can lose motivation to play the game due to demotion. Demotion due to a decrease in rank points, therefore, may occur only when a rank of the target player is a predetermined rank, such as master, or higher. That is, a player of platinum or a lower rank, for example, may remain in the same rank even if his/her rank points fall below a point threshold corresponding to the rank due to a decrease in the rank points.

Although a mode in which, when a target player wins a match for which the bet function is used, the target player is immediately promoted if his/her rank points exceed a point threshold corresponding to a higher rank as a result of an increase in the rank points has been described in the third embodiment, embodiments of the present invention are not limited to this. With respect to promotion, if rank points exceed a point threshold, the target player may be given a right to play promotion matches to determine whether the target player can be promoted to a corresponding rank, and be promoted when the target player's results of the promotion matches satisfy a promotion condition. The promotion matches may be matches with other players of the same rank, for example, and the target player is promoted if he/she wins more than half of a predetermined number of matches. The predetermined number may vary depending on the rank, and may increase as the rank becomes higher to make it more difficult to satisfy the promotion condition.

### Sixth Modification

Although a mode in which rank points to be used as the bet element are selected from the options of the predetermined amounts or the predetermined units has been described in the above third embodiment, embodiments of the present invention are not limited to this. If total rank points currently given to the target player are smaller than a minimum value that can be used as the bet element, for example, all the rank points given to the target player may be used as the bet element (so-called all-in). Alternatively, in order to increase entertainment value for the player, all-in may be selected as an option regardless of total rank points currently given to the player.

### Seventh Modification

Although a mode in which rank points can be selected as the bet element has been described in the above third embodiment and modifications, embodiments of the present invention are not limited to this. In a mode in which a game element of a type other than rank points is given to players in addition to, or instead of, the rank points, for example, the game element of this type may be selected as the bet element using the bet function. In such a mode, types of game element that can be selected by a player as the bet element may be changed in accordance with a rank into which the player is currently classified. In a mode in which types of game element that can be selected as the bet element change in accordance with a rank, a game element of a more valuable type in the competitive game may be selectable as the bet element as the rank of the player becomes higher, and the entertainment value of the competitive game can be increased by making the game element available by winning a match.

### Eighth Modification

Although various modes of a plurality of matching criteria for matching a target player who has made a matching request or extracting matching candidates have been described in the above embodiments and modifications, it is needless to say that different combinations of the matching criteria may be used, or order of priority of the individual matching criteria may be appropriately changed on the basis of another element such as content of the competitive game or the rank.

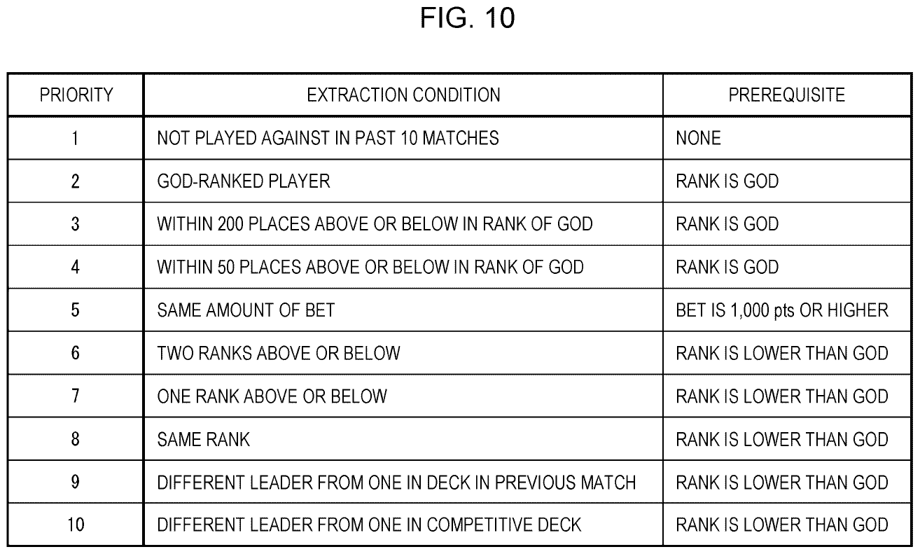

FIG. 10 illustrates a mode of such a combination. A table of FIG. 10 illustrates an example of a plurality of matching criteria referred to in the matching process for a match in the above-described rank match mode and order of priority of the matching criteria. Each of rows of the table shows an extraction condition defined for a corresponding matching criterion, a prerequisite to apply the matching criterion, and priority of the matching criterion among the plurality of matching criteria. As illustrated in FIG. 10, matching criteria shown in higher rows have higher priority, and are more likely to be used as conditions when standby players are extracted for the target player.

In the example of FIG. 10, a condition of the highest priority is that players against whom the target player has played in last 10 matches be not matched, and conditions relating to the rank of the target player, a condition relating to the bet element, and conditions relating to a leader card in a deck are defined.

In the conditions relating to the rank of the target player, different conditions are defined for a case where the target player is classified into god, which is the highest rank, and a case where the target player is classified into another rank. More specifically, when the rank of the target player is god, a matching criterion of lower priority is defined such that a standby player within 50 places above or below a position of the target player is matched, but if such a standby player does not exist, a range of standby players to be matched is sequentially expanded to standby players within 200 places above or below a place of the target player and then to standby players whose ranks are god. When the rank of the target player is not god, on the other hand, a matching criterion of lower priority is defined such that a standby player of the same rank is matched, but if such a standby player does not exist, a range of standby players to be matched is sequentially expanded to standby players one rank above or below the rank of the target player and then to standby players two ranks above or below the rank of the target player.

In the conditions relating to a leader card in a deck, as for matching criteria stipulating that the opponent be not a player who uses the same leader card as one included in a deck used by a player against whom the target player has played most recently and that the opponent be not a player who uses the same leader card as one included in a competitive deck used by the target player, a prerequisite that the rank of the target player be other than god is defined. This is because players of the highest rank of god employ diverse strategies in a match and remarkable playing skills thereof enable an exchange that does not depend on favorable/unfavorable matchups of decks.

In the condition relating to the bet element, a prerequisite that the target player bet a predetermined amount of the bet element or more is defined. A match between players who have placed so-called high bets leads to an increase in entertainment value thereof, but the following effect is also produced. For example, even if a player with high playing skills attempts to rig results of matches and accumulated rank points by repeating a high bet using a subaccount (so-called smurfing), such an activity can be prevented since a standby player of a high rank, where a high bet tends to be placed, can be matched.

### Summary of Embodiments

The above embodiments disclose at least the following program, communication terminal, and gaming system.

(1) A program causing a computer that conducts a match in a competitive game where players play against each other to perform processes including:
a construction process for constructing a competitive deck to be used in the match on a basis of an operation input by a player; and
a transmission process for transmitting, to a matching server in response to reception of an input operation relating to a start of playing of the match, a matching request to be matched with an opponent, the matching request including information regarding the competitive deck constructed in the construction process,
in which, in the competitive game, game elements of a first type and game elements of a second type, which are different from the game elements of the first type, appear,
in which a game element of the first type and a game element of the second type can be registered to the competitive deck, and
in which the matching request is transmitted to the matching server in the transmission process on a condition that the game element of the first type be registered in the competitive deck.

(2) The program according to (1), further causing the computer to perform processes including:
a conduct process for conducting the match with the opponent on a condition that the matching server have matched the player with the opponent,
in which, in the construction process before the match is conducted, a change to the game element of the first type registered in the competitive deck is unacceptable, but a change to the game element of the second type registered to the competitive deck is acceptable.

(3) The program according to (2),
in which, in the construction process while the match is being conducted, changes to the game element of the first type and the game element of the second type registered in the competitive deck is not acceptable.

(4) The program according to (2) or (3),
in which, in the conduct process, the match is conducted on a condition that the competitive deck include one game element of the first type and one or more game elements of the second type.

(5) The program according to any of (1) to (4),
in which, in the construction process, game elements selected from among game elements associated with the player through an operation input by the player are registered to the competitive deck.

(6) The program according to any of (1) to (5),
in which, in the construction process, one or more decks to be used in the match is constructible,
the program further causing the computer to perform processes including:
a selection process for selecting one of the one or more decks as the competitive deck on a basis of an operation input by the player.

(7) The program according to any of (1) to (6),
in which a progress parameter for determining whether each of the players playing against each other in the match is able to continue to play the match is set for the player,
in which the game element of the first type is a game element for which a plurality of effects that switches in accordance with the progress parameter is set, and
in which the game element of the second type is a game element for which one effect that does not switch in accordance with the progress parameter is set.

(8) A communication terminal that conducts a match in a competitive game where players play against each other, the communication terminal including:
construction means for constructing a competitive deck to be used in the match on a basis of an operation input by a player; and
transmission means for transmitting, to a matching server in response to reception of an input operation relating to a start of playing of the match, a matching request to be matched with an opponent, the matching request including information regarding the competitive deck constructed by the construction means,
in which, in the competitive game, game elements of a first type and game elements of a second type, which are different from the game elements of the first type, appear,
in which a game element of the first type and a game element of the second type can be registered to the competitive deck, and
in which the transmission means transmits the matching request to the matching server on a condition that the game element of the first type be registered in the competitive deck.

(9) A gaming system including:
a communication terminal that conducts a match in a competitive game where players play against each other; and
a matching server that matches the players with each other for the match,
in which the communication terminal includes:
construction means for constructing a competitive deck to be used in the match on a basis of an operation input by a player; and
transmission means for transmitting, to the matching server in response to reception of an input operation relating to a start of playing of the match, a matching request to be matched with an opponent, the matching request including information regarding the competitive deck constructed by the construction means,
in which, in the competitive game, game elements of a first type and game elements of a second type, which are different from the game elements of the first type, appear,
in which a game element of the first type and a game element of the second type can be registered to the competitive deck, and
in which the transmission means transmits the matching request to the matching server on a condition that the game element of the first type be registered in the competitive deck.

(10) The gaming system according to (9),
in which the matching server includes matching means for matching, for the match, a specified number of players selected from among players corresponding to received matching requests on a basis of a plurality of matching criteria, and
in which the communication terminal further includes conduct means for conducting the match in which the specified number of players participate on a condition that the matching means have matched the specified number of players.

(11) The gaming system according to (10),
in which the plurality of matching criteria includes a criterion relating to the game element of the first type, and
in which the matching means preferentially matches players with each other whose game elements of the first type registered in respective competitive decks are different from each other.

(12) The gaming system according to (11),
in which the plurality of matching criteria includes a criterion relating to a matching frequency between same players, and
in which the matching means performs control in such a way as not to match a first player corresponding to the matching request with a second player who has been matched with the first player most recently.

(13) The gaming system according to (12),
in which, among the plurality of matching criteria, the criterion relating to the matching frequency between the same players is given priority over the criterion relating to the game element of the first type.

(14) The gaming system according to any of (10) to (13),
in which attribute information is associated with each of the players,
in which the plurality of matching criteria includes a criterion relating to a degree of similarity of the attribute information associated with each of the players, and
in which the matching means matches the specified number of players associated with same or similar attribute information.

### Other Embodiments

The invention is not limited to the above embodiments, and may be modified or altered in various ways within the spirit thereof.

What is claimed is:

1. A program causing a computer that conducts a match in a competitive game where players play against each other to perform processes comprising:
a construction process for constructing a competitive deck to be used in the match on a basis of an operation input by a player; and
a transmission process for transmitting, to a matching server in response to reception of an input operation relating to a start of playing of the match, a matching request to be matched with an opponent, the matching request including information regarding the competitive deck constructed in the construction process,
wherein, in the competitive game, game elements of a first type and game elements of a second type, which are different from the game elements of the first type, appear,
wherein a game element of the first type and a game element of the second type can be registered to the competitive deck, and
wherein the matching request is transmitted to the matching server in the transmission process on a condition that the game element of the first type be registered in the competitive deck.

2. The program according to claim 1, further causing the computer to perform processes comprising:
a conduct process for conducting the match with the opponent on a condition that the matching server have matched the player with the opponent,
wherein, in the construction process before the match is conducted, a change to the game element of the first type registered in the competitive deck is unacceptable, but a change to the game element of the second type registered to the competitive deck is acceptable.

3. The program according to claim 2,
wherein, in the construction process while the match is being conducted, changes to the game element of the first type and the game element of the second type registered in the competitive deck is not acceptable.

4. The program according to claim 2,
wherein, in the conduct process, the match is conducted on a condition that the competitive deck include one game element of the first type and one or more game elements of the second type.

5. The program according to claim 1,
wherein, in the construction process, game elements selected from among game elements associated with the player through an operation input by the player are registered to the competitive deck.

6. The program according to claim 1,
wherein, in the construction process, one or more decks to be used in the match is constructible,
the program further causing the computer to perform processes comprising:
a selection process for selecting one of the one or more decks as the competitive deck on a basis of an operation input by the player.

7. The program according to claim 1,
wherein a progress parameter for determining whether each of the players playing against each other in the match is able to continue to play the match is set for the player,
wherein the game element of the first type is a game element for which a plurality of effects that switches in accordance with the progress parameter is set, and
wherein the game element of the second type is a game element for which one effect that does not switch in accordance with the progress parameter is set.

8. A communication terminal that conducts a match in a competitive game where players play against each other, the communication terminal comprising:
construction means for constructing a competitive deck to be used in the match on a basis of an operation input by a player; and
transmission means for transmitting, to a matching server in response to reception of an input operation relating to a start of playing of the match, a matching request to be matched with an opponent, the matching request including information regarding the competitive deck constructed by the construction means,
wherein, in the competitive game, game elements of a first type and game elements of a second type, which are different from the game elements of the first type, appear,
wherein a game element of the first type and a game element of the second type can be registered to the competitive deck, and
wherein the transmission means transmits the matching request to the matching server on a condition that the game element of the first type be registered in the competitive deck.

9. A gaming system comprising:
a communication terminal that conducts a match in a competitive game where players play against each other; and
a matching server that matches the players with each other for the match,
wherein the communication terminal includes:
construction means for constructing a competitive deck to be used in the match on a basis of an operation input by a player; and
transmission means for transmitting, to the matching server in response to reception of an input operation relating to a start of playing of the match, a matching request to be matched with an opponent, the matching request including information regarding the competitive deck constructed by the construction means,
wherein, in the competitive game, game elements of a first type and game elements of a second type, which are different from the game elements of the first type, appear,
wherein a game element of the first type and a game element of the second type can be registered to the competitive deck, and
wherein the transmission means transmits the matching request to the matching server on a condition that the game element of the first type be registered in the competitive deck.

10. The gaming system according to claim 9,
wherein the matching server includes matching means for matching, for the match, a specified number of players selected from among players corresponding to received matching requests on a basis of a plurality of matching criteria, and
wherein the communication terminal further includes conduct means for conducting the match in which the specified number of players participate on a condition that the matching means have matched the specified number of players.

11. The gaming system according to claim 10,
wherein the plurality of matching criteria includes a criterion relating to the game element of the first type, and
wherein the matching means preferentially matches players with each other whose game elements of the first type registered in respective competitive decks are different from each other.

12. The gaming system according to claim 11,
wherein the plurality of matching criteria includes a criterion relating to a matching frequency between same players, and
wherein the matching means performs control in such a way as not to match a first player corresponding to the matching request with a second player who has been matched with the first player most recently.

13. The gaming system according to claim 12,
wherein, among the plurality of matching criteria, the criterion relating to the matching frequency between the same players is given priority over the criterion relating to the game element of the first type.

14. The gaming system according to claim 10,
wherein attribute information is associated with each of the players,
wherein the plurality of matching criteria includes a criterion relating to a degree of similarity of the attribute information associated with each of the players, and
wherein the matching means matches the specified number of players associated with same or similar attribute information.
